(19) United States
(12) Patent Application Publication
(10) Pub. No.: US 2007/0068732 A1
(43) Pub. Date: Mar. 29, 2007

(54) Rung-extension for ladder

(76) Inventor: Walter Nagle, Courtice (CA)

Correspondence Address: BIRCH STEWART KOLASCH & BIRCH, PO BOX 747, FALLS CHURCH, VA, 22040-0747, US

(21) Appl. No.: 11/527,699

(22) Filed: Sep. 27, 2006

(30) Foreign Application Priority Data
Sep. 27, 2005 (CA) 2,521,541

(51) Int. Cl. E06C 7/16

(52) U.S. Cl. 182/121

(57) ABSTRACT

The rung-extension consists of frame having a pair of vertically extending supports and a number of vertically spaced treads which extend between the two supports. Hooks are provided for attaching the frame to a ladder such that the upper wall of each tread is at the same level a separate rung of the ladder.

### FIELD OF THE INVENTION

This invention relates to an extension for the rungs of a ladder and more particularly to an extension having treads for increasing the area of the upper surface of the rungs of the ladder. The term “rung” is intended to refer to the horizontal support of any ladder and to include not only what is commonly referred to as a “rung” but also a solid bar and a step of a stepladder.

### BACKGROUND OF THE INVENTION

The rungs of most conventional ladders provide a relatively small area of contact for the feet of persons who are using the ladders. By reason of the small area, the feet of persons who spend relatively long periods of time on ladders such as painters and electricians become very painful over time. Such persons usually experience little relief from pain if they wear boots having stiff soles. While such boots may help to reduce or even eliminate pain in their feet and ankles, they will provide little if any relief to the lower and upper parts of their legs as well as their backs and as a result, the legs of persons wearing such boots may become very painful over time.

The rung-extension of the subject invention has a number of treads which enlarge the upper areas of the rungs of a ladder. The feet of a person using a ladder to which the rung-extension is attached contact not only the rungs but also the treads of the rung-extension. The rung-extension provides foot-support which is substantially greater than the rungs and act to reduce or eliminate the pain which is experienced in the feet and legs of a person on a ladder which lacks such an extension.

Stepladders often provide inadequate support for the feet of persons on such ladders and the attachment of the subject invention is also useful for increasing the upper area of the steps of such ladders with resulting benefit to such persons.

The rung-extension of the invention has means for adjusting the device to fit onto both non-extendible and extendible ladders.

Briefly, the rung-extension of the subject invention comprises a frame provided with a tread having an upper wall for supporting a user's foot; and means for removably attaching the frame to the ladder such that the upper wall is in position to support the same said foot as is supported by a rung of the ladder.

### DESCRIPTION OF THE DRAWINGS

The rung-extension of the invention is described with reference to the accompanying drawings in which:

FIG. 1 is a perspective view of a first embodiment of the rung-extension in conjunction with a conventional extendible ladder made up of two ladder-components;

FIG. 2 is a perspective view of a non-extendible ladder and the rung-extension separated from the ladder;

FIG. 3 is a perspective view of a the rung-extension attached to a non-extendible ladder;

FIG. 4 is a side elevation of the rung-extension attached to a non-extendible ladder;

FIG. 5 is a side elevation of the rung-extension attached to an extendible ladder having two ladder components;

FIG. 6 is an elevation of a second embodiment of the rung-extension;

FIG. 7 is a front elevation of a third embodiment the rung-extension attached to a conventional non-extendible ladder having non-parallel side supports;

FIG. 8 is an enlarged perspective view of the tread of the rung-extension of FIG. 7;

FIG. 9 is a perspective view, in smaller scale, of a the rung-extension of FIG. 7 having a number of treads;

FIG. 10 is a perspective view of a fourth embodiment of the rung-extension in conjunction with a conventional non-extendible ladder; and

FIG. 11 is an elevation and partly in section on line 11-11 of FIG. 10.

Like reference characters refer to like parts throughout the description of the drawings.

### DESCRIPTION OF PREFERRED EMBODIMENTS

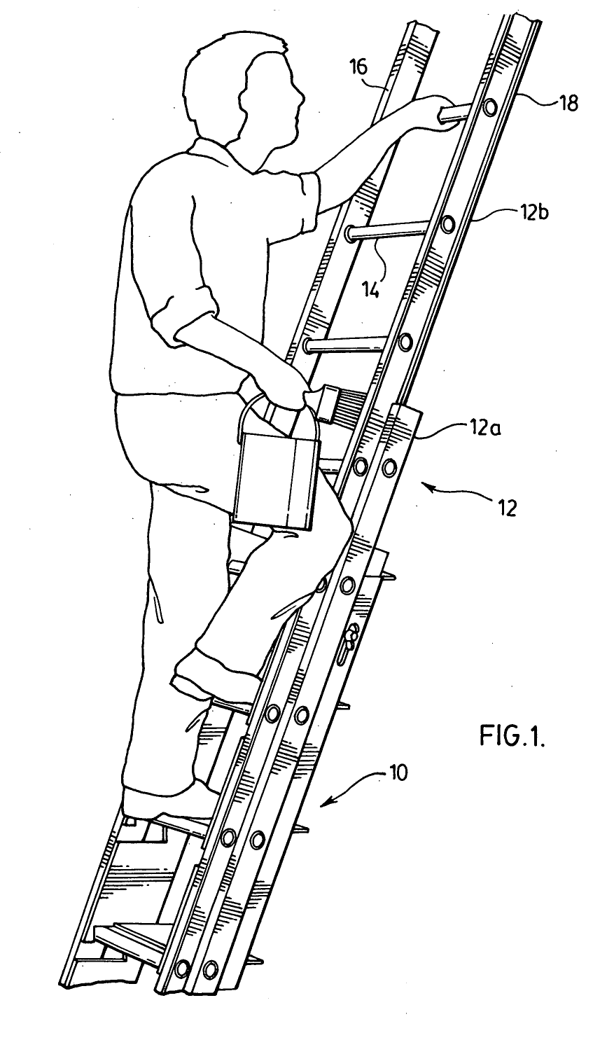

With reference of FIG. 1, the rung-extension of the invention, generally 10, is shown in conjunction with a conventional extendible ladder, generally 12 having two ladder-components 12a,b. The two ladder-components slide relative to one another to lengthen or shorten the effective length of the ladder and each has a number of vertically spaced rungs, bars or steps 14 (referred to below simply as “rungs”) fixed between two horizontally spaced supports 16, 18. As is conventional, the rungs are spaced approximately one foot apart.

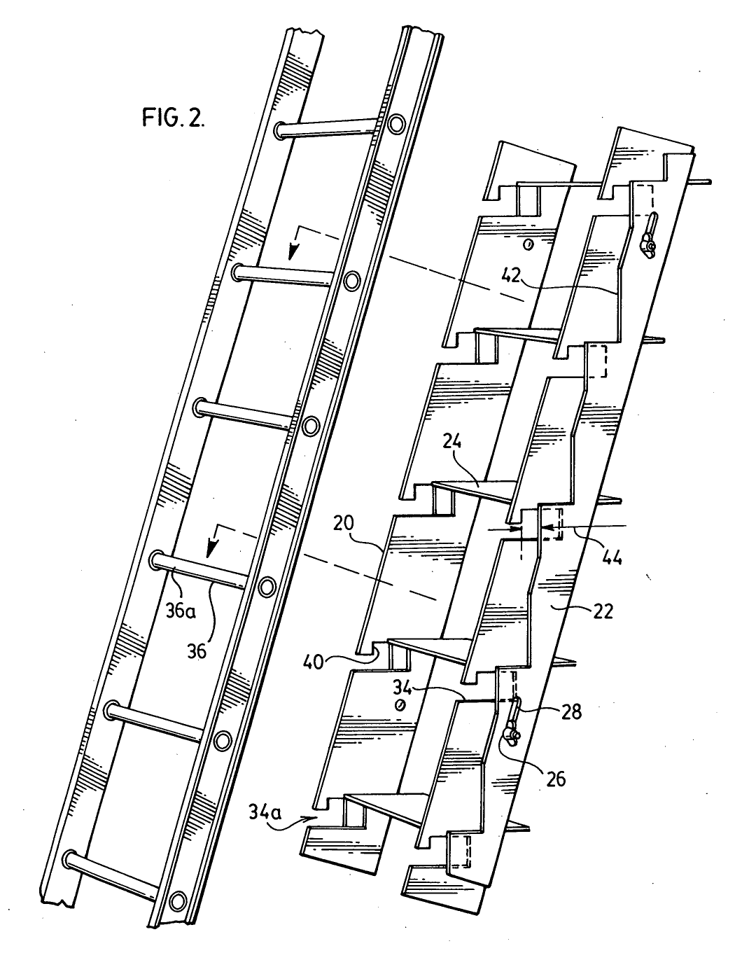

With reference to FIG. 2, the rung-extension has a pair of vertically extending stationary panels 20 and a pair of sliding panels 22 located outside the stationary panels. A number of vertically spaced treads 24 are fixed between the two stationary panels by means of bolts or rivets.

The treads are spaced apart approximately the same distance as the rungs of the ladder. That spacing will be one foot except in very unusual circumstances.

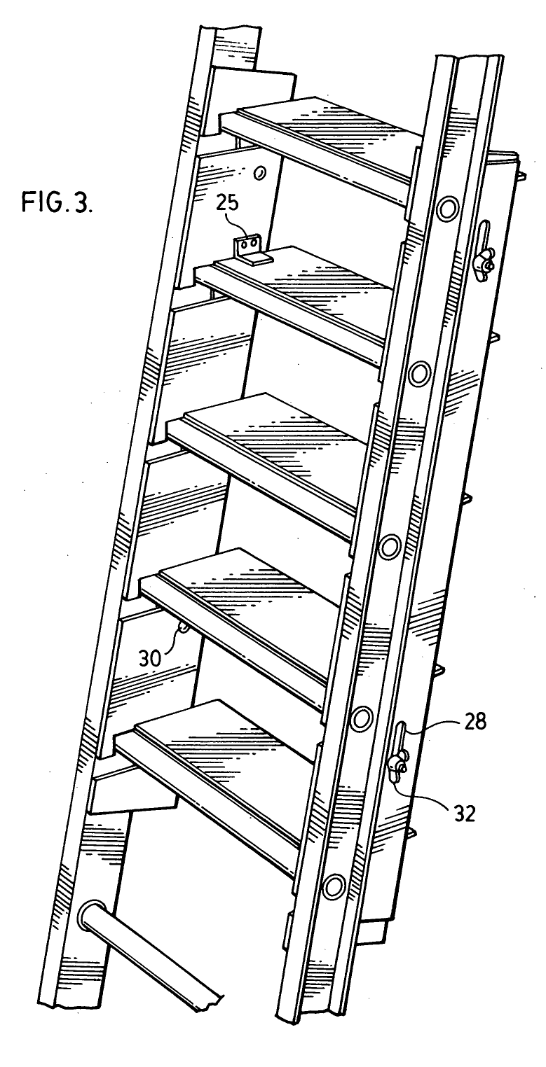

The treads can be connected to the stationary panels by means other than bolts or rivets. In FIG. 3, they are shown as being connected by hinges. In that case, one hinge is attached to the upper surface of each tread on the same side as hinge 25 while a second hinge is attached to the lower surface of each tread on the opposite side. The rung-extension can then be collapsed for storage when not in use by folding the two stationary panels together.

The two panels 20, 22 are interconnected by bolts 26, each of which extends through an aperture in the stationary panel and through a slot 28 in the sliding panel. Heads 30 and wing nuts 32 at opposite ends of the bolts secure the bolts to the panels. By means of grooves 28, the elevation of the sliding panel can be adjusted relative to the stationary panel.

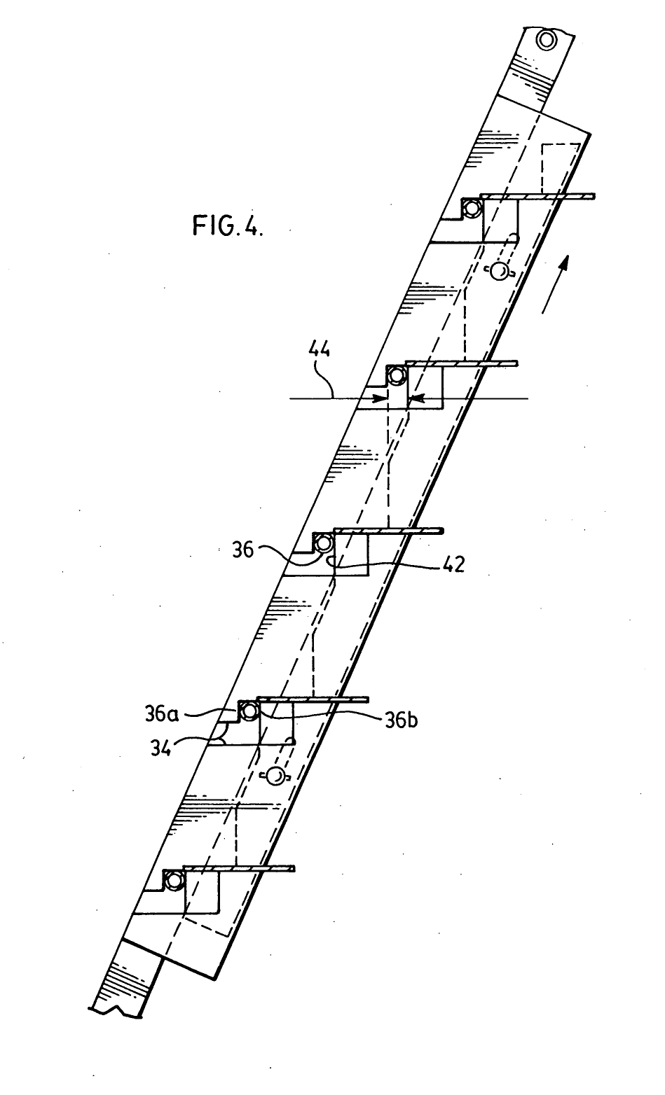

With reference to FIGS. 2 and 4, each stationary panel has a number of horizontally extending grooves 34 which are spaced vertically along the length of the panel for receipt of the rungs 36 of the ladder 38. A hook 40 extends downwardly into the mouth 34a of each groove for contacting the front face 36a of the rung and preventing the rung-extension from sliding backward and separating from the ladder when the rung-extension is in contact with the ladder.

The sliding panel 22 has a front edge 42 which is spaced apart from each hook by a gap 44 of sufficient width to receive the rungs of the ladder when the extension is the position relative to the ladder illustrated in FIG. 4. In that position the front edge 42 of the sliding panel contacts the rear face 36b of each rung and prevents the rung-extension from sliding forward relative to the rung. Accordingly, the hook and the front edge of the sliding panel cooperate with one another to minimize relative movement between the rung-extension and the rungs of the ladder when the ladder is in position for use.

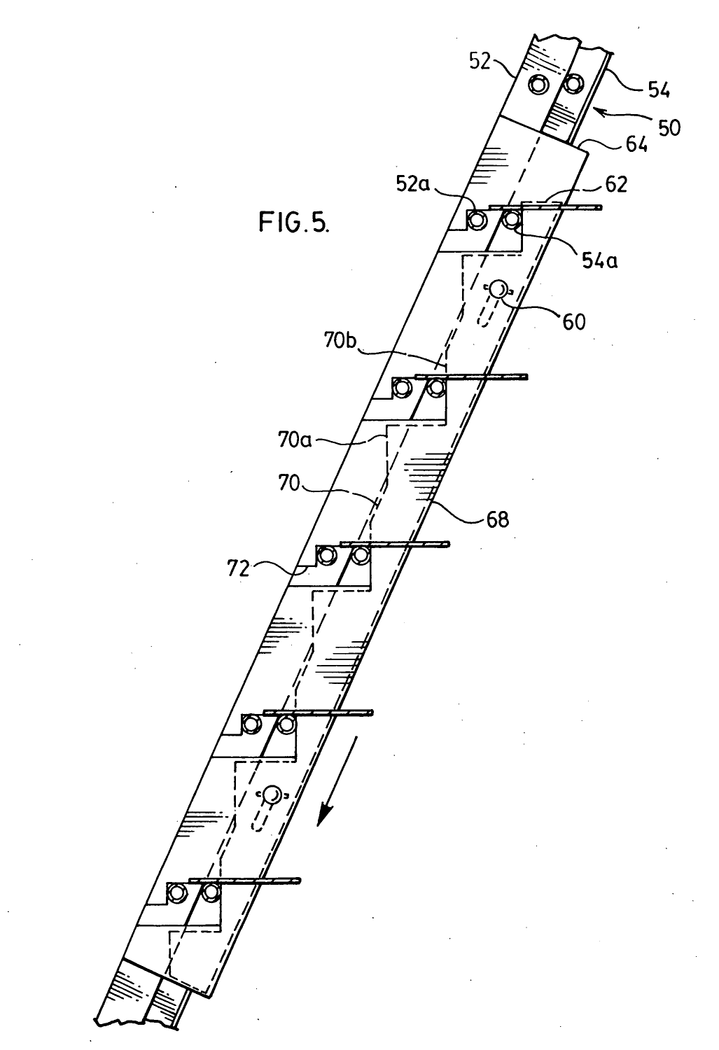

With reference to FIG. 5, the ladder, generally 50 is extendible and has forward and rear ladder-components, 52, 54 each having a number of rungs, 52a, 54a, respectively. As is conventional, the ladder is designed such that at each point at which the movement of one ladder-component is checked relative to the other, the rungs in each ladder-component are at approximately the same elevation as those of the other component.

In FIG. 4, the gap 44 between the hook and forward edge of the sliding panel is only sufficient to accommodate one rung. In FIG. 5, two rungs are accommodated in the gap and the space must be enlarged to accommodate them. The space may be enlarged by adjusting the position of the sliding panel relative to the stationary pane. In order to do so, wing nuts 60 are loosened to allow the sliding panel 62 to move downward relative to the stationary panel 64. It will be noted that the width 66 of the sliding panel, measured normally from its rear edge 68 to its forward edge 70 varies from a maximum in segment 70a of the edge to a minimum in segment 70b. As the panel moves downward, the segment of the forward edge which faces hook 72 changes from its maximum as illustrated in FIG. 4, to its minimum as illustrated in FIG. 5. When segment 70b faces hook 72, there is sufficient space to accommodate two rungs however the space is such that only minimal movement of the two rungs in the space is possible.

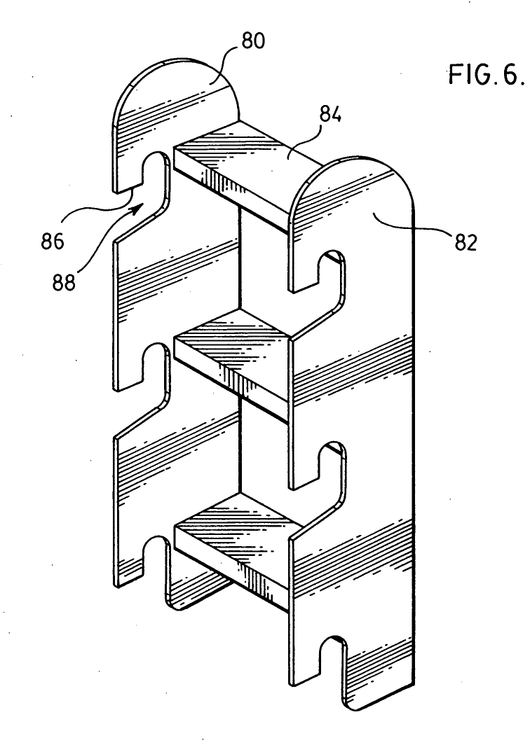

With reference to FIG. 6, a second embodiment of the rung-extension of the invention includes a pair of spaced panels 80, 82 between which treads 84 extend. A groove 88 is formed in each panel for removable receipt of any one of the rungs of a ladder. The grooves are horizontally spaced apart when the rung-extension is upright in position for use as illustrated in the drawing. A hook 86 extends downwardly into each groove and engages and prevents unintended removal of the rung from the groove.

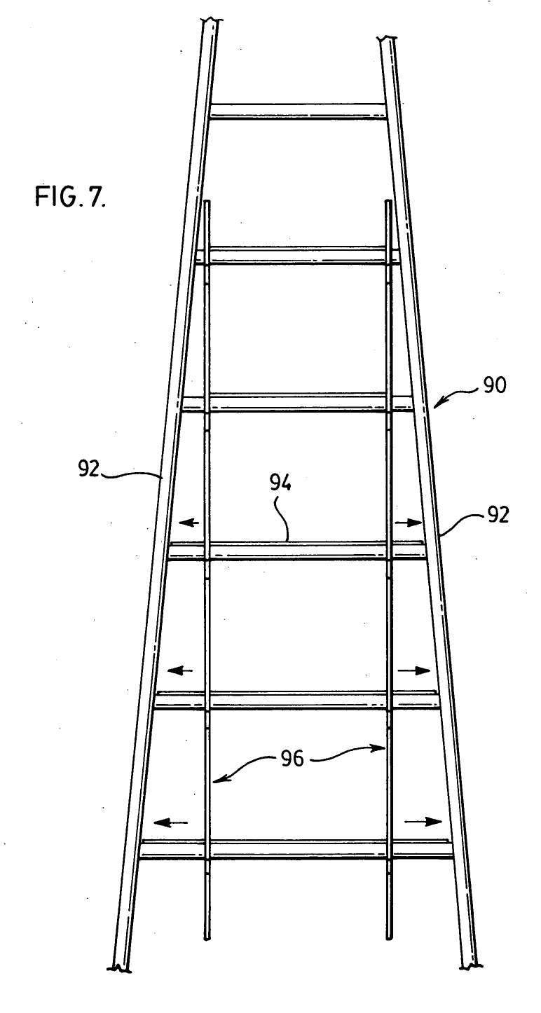

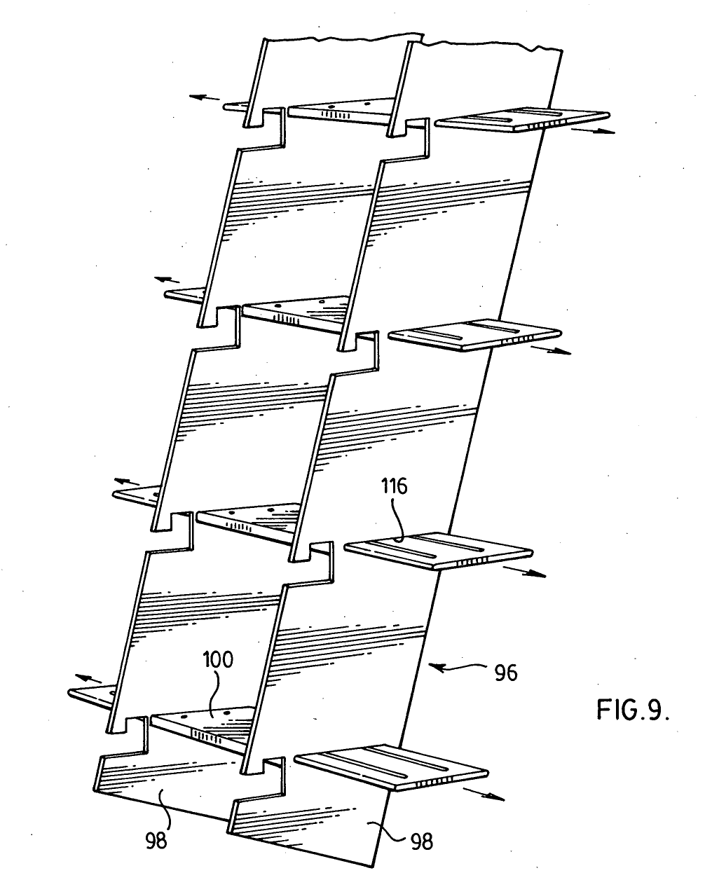

In FIGS. 7 and 9, the illustrated ladder, generally 90 has a pair of converging supports 92 to which a number of vertically spaced rungs 94 are affixed. The ladder is shown in conjunction with a third embodiment of the rung-extension of the invention, indicated generally 96. The latter extension has a pair of stationary panels 98 but lacks the sliding panels of the rung-extension described previously.

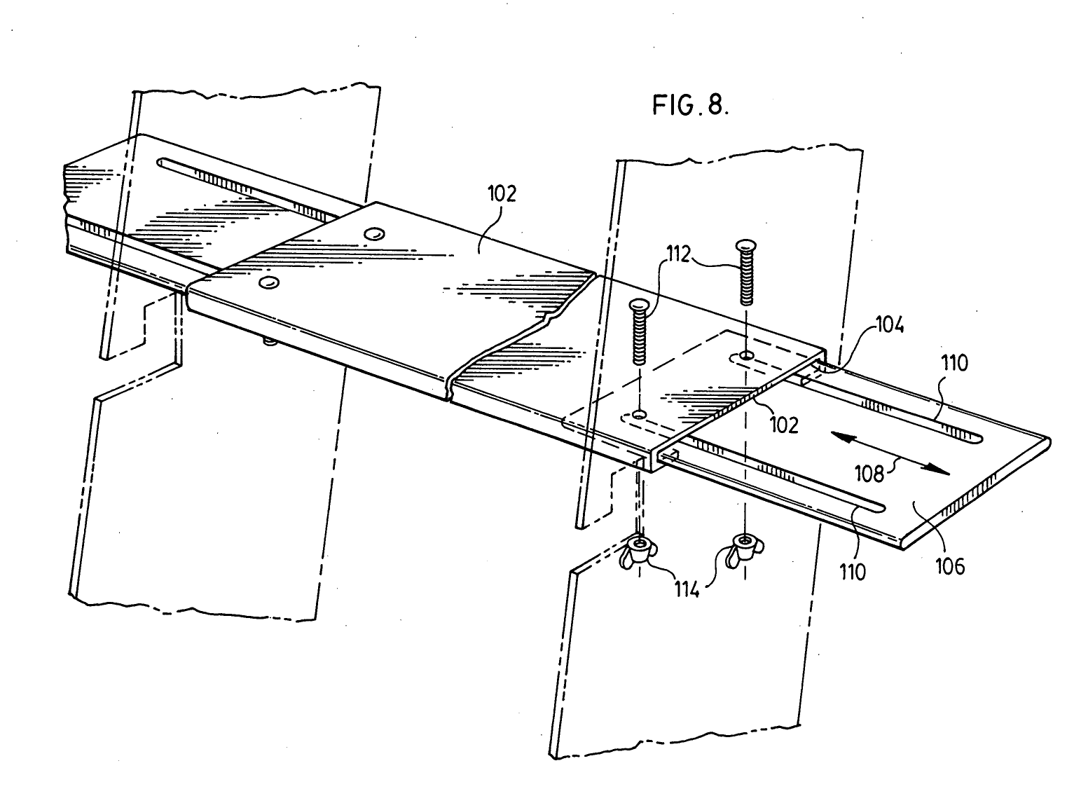

A number of vertically spaced treads 100 are attached to stationary panels 98. The treads are shown in detail in FIG. 8. With reference to that Figure and to FIG. 9, the treads each have a central channel-shaped portion 102 which opens downwardly and defines a recess 104 for receipt of a plate 106 in each end. The plates slide in and out of the recesses in the direction of arrow 108. A pair of parallel slots 110 is formed in the plates for receipt of bolts 112 which pass through openings in the central portion 102. Wing nuts 114 are threadably attached to the bolts in order to tighten the plate to the central portion. The plate may accordingly be selectively prevented or allowed to slide relative to the central portion.

The ends of the central portion extend into elongated openings 116 formed in each stationary panel and are accordingly supported by the panels. With reference to FIG. 7, the plates can be selectively extended to the converging supports 92 of the ladder in order to provide continuous treads for the user of the ladder to step on. It will be observed that the treads extend across the entire space between the two converging supports whether the treads are near the bottom of the ladder where the supports are relatively far apart or near the top where the supports are relatively close.

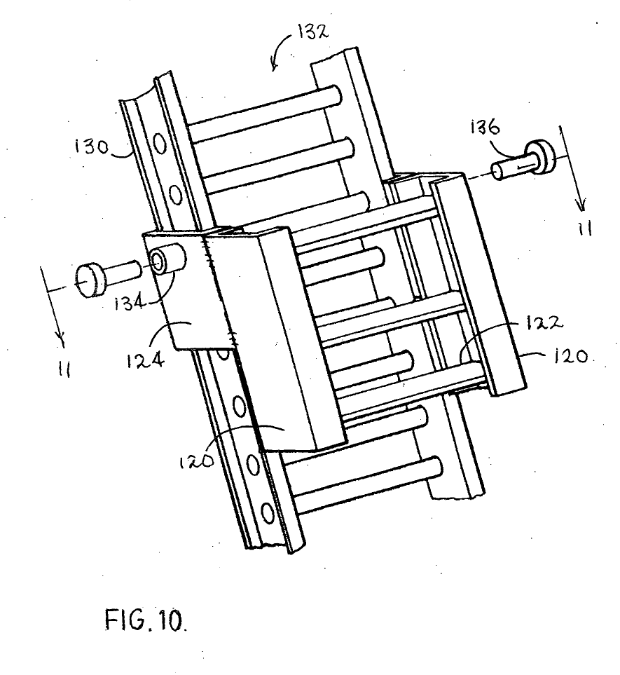

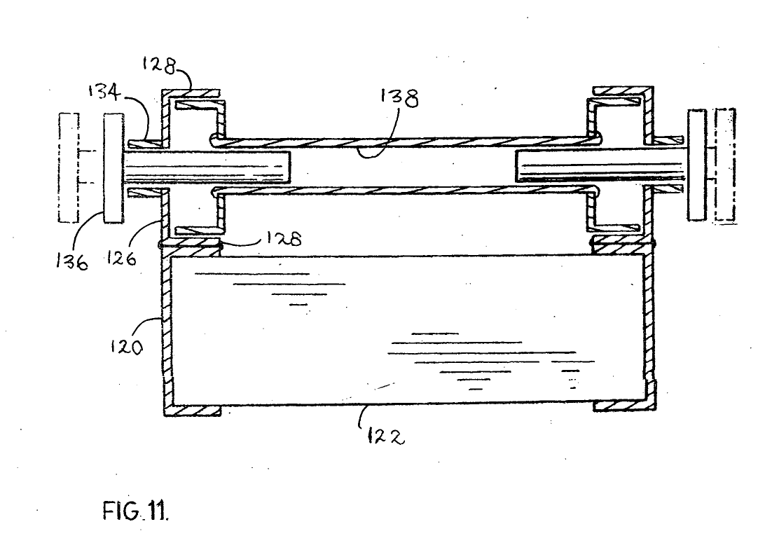

With reference to FIGS. 10 and 11, the fourth embodiment of the rung-extension of the invention has a pair of spaced panels 120 between which treads 122 extends. A connector 124 is attached to each panel and each connector is in the shape of a channel having a web 126 and a pair of flanges 128 at opposite side edges of the web. Each connector extends around three walls of a separate support 130 of a conventional ladder, generally 132.

A collar 134 is fastened to each connector and each collar ends at an aperture formed in the web of the connector. The collars are both at the same elevation when the rung-extension is in position for use as illustrated in FIG. 10.

A pin 136 is removably received in each collar. When the pin is inserted into the collar, it will pass through the opening in the web and through the hollow opening 138 of each rung of the ladder.

The pin in each connector serves to attach the connector to the ladder with resulting attachment of the rung-extension to the ladder. When the pins are removed, the connectors of the rung-extension can be slid up and down the ladder in order to alter the position of the rung-extension on the ladder.

It will be understood, of course, that modification can be made in the embodiments of the rung-extension of the subject invention without departing from the scope and purview of the invention as defined in the appended claims.

I claim:

1. A rung-extension for a ladder having a pair of spaced supports and a plurality of rungs which extend between said supports, said rung-extension including a tread having an upper wall for supporting a user's foot; and means for removably attaching said rung-extension to said ladder such that said upper wall is in position to provide additional support to the foot that is supported by one of said rungs.

2. The rung-extension of claim 1 further including a hook for engaging said rung such that said upper wall is approximately at the same elevation as the area of said rung adapted to be contacted by said foot.

3. The rung-extension of claim 2 wherein said hook defines, in part, a gap of sufficient width to receive said rung; and means for selectively increasing the width of said gap.

4. The rung-extension of claim 1 further including a pair of spaced panels between which said tread extends, said attaching means including a groove formed in each said panel for removable receipt of any one of said rungs, and a hook which extends into said groove and which engages and prevents unintended removal of said removably received rung from said groove.

5. The rung-extension of claim 1 further including a pair of spaced panels between which said tread extends, said attaching means including: a connector which extends outwardly from each said panel and which is adapted to be disposed adjacent to one said support when said rung-extension is attached to said ladder, said connector having an opening formed therein; and a pin removably received in said opening and in an opening formed in said one support for attaching said connector to said one support.

6. A rung-extension for a ladder having a plurality of spaced rungs, said rung-extension having a plurality of spaced treads each having an upper wall for supporting a user's foot; and means for removably attaching said rung-extension to said ladder such that each said upper wall is associated with a separate said rung and is in position to provide additional support to the foot that is supported by said separate rung.

7. The rung-extension of claim 6 wherein said attaching means is a hook for engaging each said rung such that each said upper wall is associated with a separate said rung.

8. The rung-extension of claim 6 further including means for extending the effective length of at least one of said upper walls.

9. The rung-extension of claim 6 further including a pair of spaced panels between which said treads extend, said attaching means including a groove formed in each said panel for removable receipt of any one of said rungs, and a hook which extends into said groove and which engages and prevents unintended removal of said removably received rung.

10. The rung-extension of claim 6 further including a pair of spaced panels between which said tread extends, said attaching means including: a connector which extends outwardly from each said panel and which is adapted to be disposed adjacent to one said support when said rung-extension is attached to said ladder, said connector having an opening formed therein; and a pin removably received in said opening and in an opening formed in said one support for attaching said connector to said one support.

11. A rung-extension for an extendible ladder having a pair of ladder-components each of which ladder-components having a pair of spaced supports and a plurality of rungs fixed between said supports, said rungs having an upper area adapted to be contacted by a foot of the user of said extendible ladder, said rung-extension comprising: a tread having an upper wall for supporting a user's foot; and means for removably attaching said rung-extension to at least one of said ladder-components such that said upper wall is in position to support the same said foot as is supported by one of said rungs of said one ladder-component.

12. The rung-extension of claim 11 wherein said attaching means is a hook for engaging said one rung such that said upper wall is approximately at the same elevation as said area of said one rung.

13. The rung-extension of claim 11 wherein said hook defines, in part, a gap of sufficient width to receive said one rung; and means for selectively increasing the width of said gap to receive one of said rungs in the other said ladder component.
